(19) United States
(12) Patent Application Publication
(10) Pub. No.: US 2026/0163648 A1
(43) Pub. Date: Jun. 11, 2026

(54) FREQUENCY TRANSITION DEVICE AND COMMUNICATION DEVICE

(71) Applicant: Mitsubishi Electric Corporation, Tokyo (JP)

(72) Inventors: Seiki NAKAMURA, Tokyo (JP); Junya NISHIOKA, Tokyo (JP); Takatoshi AKAMATSU, Tokyo (JP)

(73) Assignee: Mitsubishi Electric Corporation, Tokyo (JP)

(21) Appl. No.: 19/179,020

(22) Filed: Apr. 15, 2025

Related U.S. Application Data
(63) Continuation of application No. PCT/JP2023/000029, filed on Jan. 5, 2023.

(51) Int. Cl. H04B 10/54

(52) U.S. Cl. CPC H04B 10/54; H04B 2210/006

(57) ABSTRACT

A frequency transition device includes: a light wavelength multiplexing unit to perform wavelength multiplexing on pilot light with respect to carrier light; and a light intensity modulation unit to perform light intensity modulation on post-pilot light multiplexing carrier light obtained by the light wavelength multiplexing unit with a frequency transition target signal, and output intensity modulation light. Furthermore, the frequency transition device includes: a light wavelength demultiplexing unit to demultiplex the intensity modulation light output from the light intensity modulation unit into a wavelength component of the carrier light and a wavelength component of the pilot light; a light pulse compression unit to compress the wavelength component of the carrier light along a time axis, and output time compression pulse light; and a control unit to control the light intensity modulation of the light intensity modulation unit.

### CROSS REFERENCE TO RELATED APPLICATIONS

This application is a Continuation of PCT International Application No. PCT/JP2023/000029 filed on January 5, 2023, all of which is hereby expressly incorporated by reference into the present application.

### TECHNICAL FIELD

The present disclosure relates to a frequency transition device and a communication device.

### BACKGROUND ART

There is a frequency transition device that causes the frequency of a frequency transition target signal frequency to transit.

As for such a frequency transition device, for example, Patent Literature 1 discloses a device that includes an optical carrier wave generation unit, a modulator, a dispersion compensator, and a photoelectric converter.

The optical carrier wave generation unit generates an optical carrier wave. The modulator modulates the optical carrier wave generated by the optical carrier wave generation unit with a first electrical signal. The first electrical signal is a frequency transition target signal. The dispersion compensator compresses along a time axis the optical carrier wave modulated by the modulator. The photoelectric converter converts the optical carrier wave compressed by the dispersion compensator into a second electrical signal. The second electrical signal is a post-frequency transition signal whose frequency is higher than that of the first electrical signal.

### CITATION LIST

### PATENT LITERATURE

Patent Literature 1: WO 2021/ 079710 A

### SUMMARY OF INVENTION

### TECHNICAL PROBLEM

In the device disclosed in Patent Literature 1, a temperature drift may occur in the modulator when, for example, the temperature in surroundings of the modulator changes. Furthermore, as the time passes, a drift over time may occur in the modulator. There has been a problem that, when a temperature drift, a drift over time, or the like occurs in the modulator, a signal level of the second electrical signal deviates from its original signal level.

The present disclosure has been made to solve the above problem, and an object of the present disclosure is to provide a frequency transition device that, even if a signal level of a post-frequency transition signal deviates from the original signal level, can recover the signal level of the post-frequency transition signal to the original signal level.

### SOLUTION TO PROBLEM

A frequency transition device according to the present disclosure includes: a light wavelength multiplexer to perform wavelength multiplexing on pilot light with respect to carrier light, the pilot signal having a wavelength different from a wavelength of the carrier light; and a light intensity modulator to perform light intensity modulation on post-pilot light multiplexing carrier light obtained by the light wavelength multiplexer with a frequency transition target signal, and output intensity modulation light that is post-light intensity modulation carrier light. Furthermore, the frequency transition device includes: a light wavelength demultiplexer to demultiplex the intensity modulation light output from the light intensity modulator into a wavelength component of the carrier light and a wavelength component of the pilot light; a light pulse compressor to compress the wavelength component of the carrier light along a time axis, and output time compression pulse light that is the compressed wavelength component of the carrier light; and a controller to control a light intensity of the intensity modulation light output from the light intensity modulator on a basis of the wavelength component of the pilot light.

### ADVANTAGEOUS EFFECTS OF INVENTION

According to the present disclosure, even if a signal level of a post-frequency transition signal that is an electrical signal converted from time compression pulse light deviates from the original signal level, it is possible to recover the signal level of the post-frequency transition signal to the original signal level.

### BRIEF DESCRIPTION OF DRAWINGS

FIG. 1 is a configuration diagram illustrating a communication device including a frequency transition device 1 according to Embodiment 1.

FIG. 2 is a configuration diagram illustrating the frequency transition device 1 according to Embodiment 1.

FIG. 3 is an explanatory view illustrating short pulse light P_{C} and carrier light P_{CAR}.

FIG. 4A is an explanatory view illustrating a time waveform of each of the carrier light P_{CAR} and pilot light P_{PIL}, FIG. 4B is an explanatory view illustrating carrier light P_{CAR+PIL} on which the pilot light P_{PIL} has been subjected to wavelength multiplexing, and FIG. 4C is an explanatory view illustrating the wavelength of each of the carrier light P_{CAR} and the pilot light P_{PIL}.

FIG. 5 is an explanatory view illustrating a time waveform of an RF signal (1).

FIG. 6 is an explanatory view illustrating a time waveform of intensity modulation light P_{IM}.

FIG. 7A is an explanatory view illustrating a time waveform of a wavelength component of the carrier light P_{CAR}, and FIG. 7B is an explanatory view illustrating a time waveform of the wavelength component of the pilot light P_{PIL}.

FIG. 8 is an explanatory view illustrating a time waveform of time compression pulse light P_{TC}.

FIG. 9 is an explanatory view illustrating a time waveform of an RF signal (2).

FIG. 10 is a configuration diagram illustrating the frequency transition device 1 according to Embodiment 2.

FIG. 11A is an explanatory view illustrating a time waveform of each of post-waveform shaping carrier light P_{CAR}’ and the pilot light P_{PIL}, FIG. 11B is an explanatory view illustrating post-waveform shaping carrier light P_{CAR’+PIL} on which the pilot light P_{PIL} has been subjected to wavelength multiplexing, and FIG. 11C is an explanatory view illustrating the wavelength of each of the carrier light P_{CAR}’ and the pilot light P_{PIL}.

### DETAILED DESCRIPTION OF THE EMBODIMENTS

Hereinafter, a mode for carrying out the present disclosure will be described with reference to the accompanying drawings to describe the present disclosure in more detail.

### Embodiment 1.

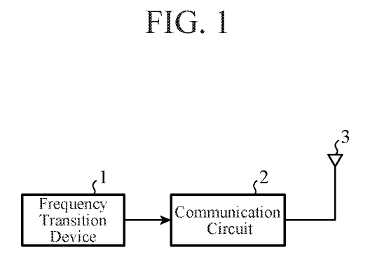

FIG. 1 is a configuration diagram illustrating a communication device including a frequency transition device 1 according to Embodiment 1.

The communication device illustrated in FIG. 1 includes the frequency transition device 1, a communication circuit 2, and an antenna 3.

The frequency transition device 1 is a device that causes a frequency f₁ of a Radio Frequency (RF) signal (1) that is a frequency transition target signal to transition to another frequency f₂, and outputs an RF signal (2) with frequency f₂.

The frequency transition device 1 outputs the post-frequency transition RF signal (2) to the communication circuit 2.

Examples of the frequency f₂ of the RF signal (2) include the frequency of a microwave band, the frequency of a millimeter wave band, or the frequency of a terahertz wave band.

In the example in FIG. 1, the frequency transition device 1 is mounted in the communication device. However, this is merely an example, and the frequency transition device 1 may be mounted in a device other than the communication device.

The communication circuit 2 outputs to the antenna 3 the RF signal (2) output from the frequency transition device 1.

Note that the communication circuit 2 performs general signal processing such as modulation processing on the RF signal (2) output from the frequency transition device 1, and the RF signal (2) output from the communication circuit 2 to the antenna 3 is a signal subjected to the modulation processing or the like by the communication circuit 2. Since the general signal processing such as the modulation processing of the RF signal (2) is a known technique, detailed description thereof will be omitted.

The antenna 3 radiates to space a radio wave that is based on the RF signal (2) output from the communication circuit 2.

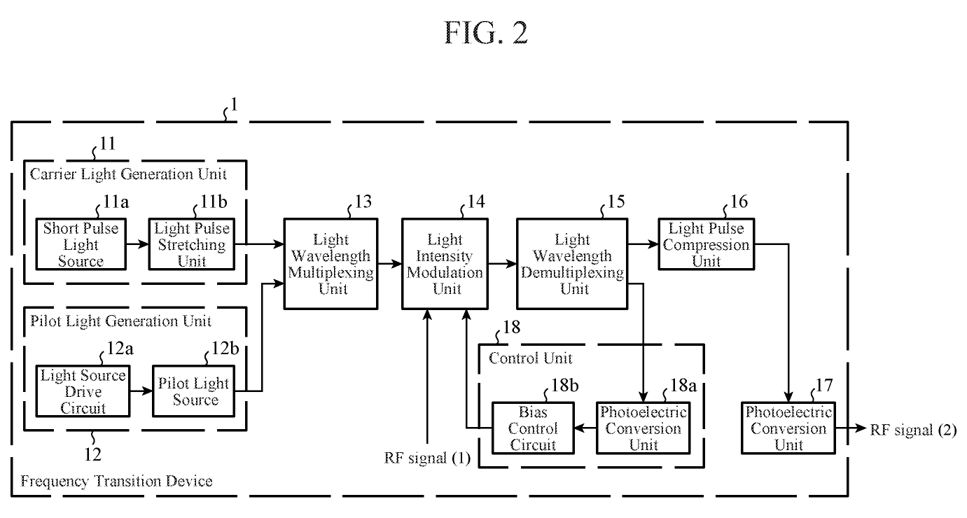

FIG. 2 is a configuration diagram illustrating the frequency transition device 1 according to Embodiment 1.

The frequency transition device 1 illustrated in FIG. 2 includes a carrier light generation unit 11, a pilot light generation unit 12, a light wavelength multiplexing unit 13, a light intensity modulation unit 14, a light wavelength demultiplexing unit 15, a light pulse compression unit 16, a photoelectric conversion unit 17, and a control unit 18.

In the frequency transition device 1 illustrated in FIG. 2, the following components are connected, for example, by optical fibers: the carrier light generation unit 11 and the light wavelength multiplexing unit 13, the pilot light generation unit 12 and the light wavelength multiplexing unit 13, the light wavelength multiplexing unit 13 and the light intensity modulation unit 14, the light intensity modulation unit 14 and the light wavelength demultiplexing unit 15, the light wavelength demultiplexing unit 15 and the light pulse compression unit 16, the light pulse compression unit 16 and the photoelectric conversion unit 17, and the light wavelength demultiplexing unit 15 and the control unit 18.

The carrier light generation unit 11 includes a short pulse light source 11a and a light pulse stretching unit 11b.

The carrier light generation unit 11 generates carrier light P_{CAR} by stretching pulse light (hereinafter, referred to as “short pulse light”) P_{C} of a wavelength λ_{C} [nm] along the time axis, and outputs the generated carrier light P_{CAR} to the light wavelength multiplexing unit 13.

The short pulse light source 11a is implemented by, for example, a mode locked fiber laser.

The short pulse light source 11a repeatedly oscillates the short pulse light P_{C} of the wavelength λ_{C} [nm], and repeatedly outputs the short pulse light P_{C} to the light pulse stretching unit 11b. The pulse width of the short pulse light P_{C} is W1, and an oscillation cycle of the short pulse light P_{C} is D.

The light pulse stretching unit 11b is implemented by, for example,apassive optical component that uses a dispersive medium.

The light pulse stretching unit 11b performs wavelength dispersion of stretching the short pulse light P_{C} output from the short pulse light source 11a along the time axis.

The light pulse stretching unit 11b outputs the carrier light P_{CAR} that is post-wavelength dispersion short pulse light to the light wavelength multiplexing unit 13. A wavelength range of the carrier light P_{CAR} is in, for example, a range of λ_{C}-α to λ_{C}+α.

The pilot light generation unit 12 includes a light source drive circuit 12a and a pilot light source 12b.

The pilot light generation unit 12 generates pilot light P_{PIL} having a different wavelength λ_{P} [nm] from that of the carrier light P_{CAR} generated by the carrier light generation unit 11, and outputs the generated pilot light P_{PIL} to the light wavelength multiplexing unit 13.

The light source drive circuit 12a is implemented by, for example, a Field Programmable Gate Array (FPGA).

The light source drive circuit 12a is a control circuit that drives the pilot light source 12b in such a way that the pilot light source 12b outputs continuous light (hereinafter, referred to as “CW light”).

The pilot light source 12b is implemented by, for example, a semiconductor laser.

The pilot light source 12b oscillates the CW light as the pilot light P_{PIL} of the wavelength λ_{P} different from that of the carrier light P_{CAR}, and outputs the pilot light P_{PIL} to the light wavelength multiplexing unit 13.

The light wavelength multiplexing unit 13 includes, for example, a wavelength division multiplexing coupler, an array waveguide grating, and an optical multiplexer.

The light wavelength multiplexing unit 13 receives the carrier light P_{CAR} from the carrier light generation unit 11, and receives the pilot light P_{PIL} from the pilot light generation unit 12.

The light wavelength multiplexing unit 13 performs wavelength multiplexing on the pilot light P_{PIL} with respect to the carrier light P_{CAR} to generate carrier light P_{CAR+PIL}. The carrier light P_{CAR+PIL} is post-pilot light multiplexing carrier light.

The light wavelength multiplexing unit 13 outputs the carrier light P_{CAR+PIL} to the light intensity modulation unit 14.

The light intensity modulation unit 14 is implemented by, for example, a Mach-Zehnder modulator, an electro-absorption modulator, or an acousto-optic modulator.

The light intensity modulation unit 14 receives the RF signal (1) that is a frequency transition target signal from the outside, receives the carrier light P_{CAR+PIL} from the light wavelength multiplexing unit 13, and a bias signal B from the control unit 18.

The light intensity modulation unit 14 performs light intensity modulation on the carrier light P_{CAR+PIL} with the RF signal (1). The light intensity modulation of the light intensity modulation unit 14 is controlled in accordance with the bias signal B.

The light intensity modulation unit 14 outputs intensity modulation light P_{IM} that is the post-light intensity modulation carrier light to the light wavelength demultiplexing unit 15.

The light wavelength demultiplexing unit 15 includes, for example, a wavelength division multiplexing coupler, an array waveguide grating, and an optical demultiplexer.

The light wavelength demultiplexing unit 15 receives the intensity modulation light P_{IM} from the light intensity modulation unit 14.

The light wavelength demultiplexing unit 15 demultiplexes the intensity modulation light P_{IM} into a wavelength component of the carrier light P_{CAR} and a wavelength component of the pilot light P_{PIL}.

The light wavelength demultiplexing unit 15 outputs the wavelength component of the carrier light P_{CAR} to the light pulse compression unit 16, and outputs the wavelength component of the pilot light P_{PIL} to the control unit 18.

The light pulse compression unit 16 is implemented by, for example, a passive optical component that uses a dispersive medium.

The light pulse compression unit 16 receives the wavelength component of the carrier light P_{CAR} from the light wavelength demultiplexing unit 15.

The light pulse compression unit 16 compresses the wavelength component of the carrier light P_{CAR} along the time axis.

The light pulse compression unit 16 outputs time compression pulse light P_{TC} that is the compressed wavelength component of the carrier light P_{CAR} to the photoelectric conversion unit 17.

The photoelectric conversion unit 17 is implemented by, for example, a photodiode.

The photoelectric conversion unit 17 receives the time compression pulse light P_{TC} from the light pulse compression unit 16.

The photoelectric conversion unit 17 converts the time compression pulse light P_{TC} into an electrical signal, and outputs the RF signal (2) that is the electrical signal as a post-frequency transition signal to the communication circuit 2. The frequency f₂ of the RF signal (2) is higher than the frequency f₁ of the RF signal (1).

In the frequency transition device 1 illustrated in FIG. 2, the photoelectric conversion unit 17 outputs the RF signal (2) to the communication circuit 2. However, this is merely an example, and the photoelectric conversion unit 17 may output the RF signal (2) to a device other than the communication circuit 2.

The control unit 18 includes a photoelectric conversion unit 18a and a bias control circuit 18b.

The control unit 18 receives the wavelength component of the carrier light P_{PIL} from the light wavelength demultiplexing unit 15.

The control unit 18 controls light intensity modulation of the light intensity modulation unit 14 on the basis of the wavelength component of the pilot light P_{PIL}.

The photoelectric conversion unit 18a is implemented by, for example, a photodiode.

The photoelectric conversion unit 18a receives the wavelength component of the pilot light P_{PIL} from the light wavelength demultiplexing unit 15.

The photoelectric conversion unit 18a converts the wavelength component of the pilot light P_{PIL} into an electrical signal E, and outputs the electrical signal E to the bias control circuit 18b.

The bias control circuit 18b is implemented by, for example, a bias controller.

The bias control circuit 18b receives the electrical signal E from the photoelectric conversion unit 18a.

The bias control circuit 18b controls the light intensity modulation of the light intensity modulation unit 14 by controlling the bias signal B to be applied to the light intensity modulation unit 14 on the basis of the electrical signal E.

Next, an operation of the frequency transition device 1 illustrated in FIG. 2 will be described.

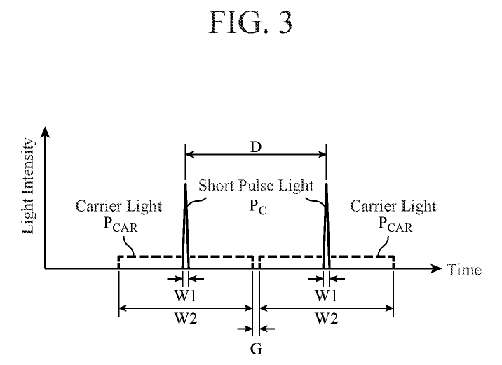

The short pulse light source 11a of the carrier light generation unit 11 repeatedly oscillates the short pulse light P_{C} of the wavelength λ_{C} as illustrated in FIG. 3.

The short pulse light source 11a repeatedly outputs the short pulse light P_{C} to the light pulse stretching unit 11b.

The light pulse stretching unit 11b performs wavelength dispersion of stretching the short pulse light P_{C} along the time axis as illustrated in FIG. 3 every time the light pulse stretching unit 11b receives the short pulse light P_{C} from the short pulse light source 11a.

The light pulse stretching unit 11b outputs the carrier light P_{CAR} that is the post-wavelength dispersion short pulse light to the light wavelength multiplexing unit 13.

FIG. 3 is an explanatory view illustrating the short pulse light P_{C} and the carrier light P_{CAR}.

In FIG. 3, the horizontal axis indicates a time, and the vertical axis indicates a light intensity of each of the short pulse light P_{C} and the carrier light P_{CAR}.

W1 represents the pulse width of the short pulse light P_{C}, and D represents the oscillation cycle of the short pulse light P_{C} of the short pulse light source 11a.

W2 represents the pulse width of the carrier light P_{CAR}.

G represents a gap time of two temporally neighboring beams of the carrier light P_{CAR}.

The gap time G is a time during which the light intensity modulation unit 14 cannot perform light intensity modulation on the carrier light P_{CAR+PIL} with the RF signal (1). As the pulse width W2 of the carrier light P_{CAR} becomes wider and the gap time G becomes shorter, the time during which the light intensity modulation unit 14 cannot perform light intensity modulation on the carrier light P_{CAR+PIL} with the RF signal (1) decreases. In other words, a time during which the light intensity modulation unit 14 can perform light intensity modulation on the carrier light P_{CAR+PIL} with the RF signal (1) increases.

Hence, the light pulse stretching unit 11b desirably stretches the short pulse light P_{C} along the time axis as much as possible within such a range that the two temporally neighboring beams of the carrier light P_{CAR} do not overlap each other (G ≥ 0).

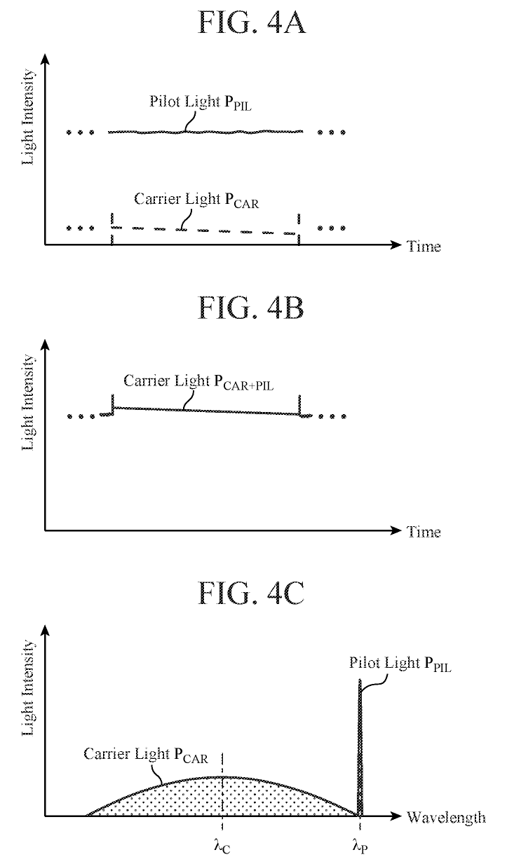

The pilot light source 12b of the pilot light generation unit 12 oscillates the CW light as the pilot light P_{PIL} of the wavelength λ_{P} different from that of the carrier light P_{CAR} as illustrated in FIG. 4C. The wavelength λ_{P} [nm] of the pilot light P_{PIL} is a wavelength that does not overlap a wavelength range of the carrier light P_{CAR}.

FIG. 4C illustrates an example where the wavelength λ_{P} of the pilot light P_{PIL} is longer than the wavelength range of the carrier light P_{CAR}. However, this is merely an example, and the wavelength λ_{P} of the pilot light P_{PIL} may be shorter than the wavelength range of the carrier light P_{CAR}.

Oscillation of the CW light by the pilot light source 12b is controlled by the light source drive circuit 12a.

The pilot light source 12b outputs the pilot light P_{PIL} to the light wavelength multiplexing unit 13.

FIG. 4A is an explanatory view illustrating a time waveform of each of the carrier light P_{CAR} and the pilot light P_{PIL}. In FIG. 4A, the horizontal axis indicates a time, and the vertical axis indicates a light intensity of each of the carrier light P_{CAR} and the pilot light P_{PIL}.

FIG. 4B is an explanatory view illustrating the carrier light P_{CAR+PIL} on which the pilot light P_{PIL} has been subjected to wavelength multiplexing. In FIG. 4B, the horizontal axis indicates a time, and the vertical axis indicates the light intensity of the carrier light P_{CAR+PIL}.

FIG. 4C is an explanatory view illustrating the wavelength of each of the carrier light P_{CAR} and the pilot light P_{PIL}. In FIG. 4C, the horizontal axis indicates a wavelength, and the vertical axis indicates a light intensity of each of the carrier light P_{CAR} and the pilot light P_{PIL}.

In the example in FIG. 4A, the light intensity of the pilot light P_{PIL} is greater than the light intensity of the carrier light P_{CAR}. However, this is merely an example, and the light intensity of the pilot light P_{PIL} is not limited to a light intensity greater than the light intensity of the carrier light P_{CAR}. In this regard, the light intensity of the pilot light P_{PIL} output from the pilot light source 12b is a constant light intensity.

The wavelength of the pilot light P_{PIL} is a wavelength that does not interfere with the wavelength of the carrier light P_{CAR} as illustrated in FIG. 4C.

The light wavelength multiplexing unit 13 receives the carrier light P_{CAR} illustrated in FIG. 4A from the carrier light generation unit 11, and receives the pilot light P_{PIL} illustrated in FIG. 4A from the pilot light generation unit 12.

The light wavelength multiplexing unit 13 performs wavelength multiplexing on the pilot light P_{PIL} with respect to the carrier light P_{CAR} to generate the carrier light P_{CAR+PIL} illustrated in FIG. 4B.

The light wavelength multiplexing unit 13 outputs the carrier light P_{CAR+PIL} to the light intensity modulation unit 14.

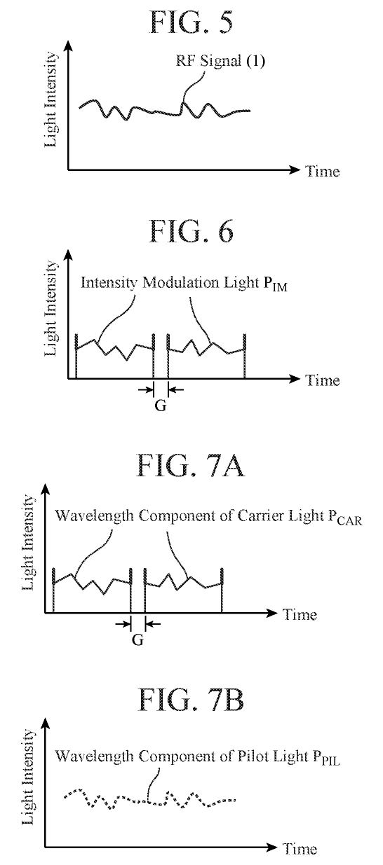

The light intensity modulation unit 14 receives the RF signal (1) illustrated in FIG. 5 from the outside, receives the carrier light P_{CAR+PIL} from the light wavelength multiplexing unit 13, and receives the bias signal B from the control unit 18.

FIG. 5 is an explanatory view illustrating a time waveform of the RF signal (1).

In FIG. 5, the horizontal axis indicates a time, and the vertical axis indicates the light intensity of the RF signal (1).

The light intensity modulation unit 14 performs light intensity modulation on the carrier light P_{CAR+PIL} with the RF signal (1).

The light intensity modulation unit 14 outputs the intensity modulation light P_{IM} that is the post-light intensity modulation carrier light to the light wavelength demultiplexing unit 15.

The light intensity modulation of the light intensity modulation unit 14 is controlled in accordance with the bias signal B. The light intensity of the intensity modulation light P_{IM} changes as the RF signal (1) changes over time as illustrated in FIG. 6.

FIG. 6 is an explanatory view illustrating the time waveform of the intensity modulation light P_{IM}.

In FIG. 6, the horizontal axis indicates a time, and the vertical axis indicates the light intensity of the intensity modulation light P_{IM}.

The light wavelength demultiplexing unit 15 receives the intensity modulation light P_{IM} from the light intensity modulation unit 14.

The light wavelength demultiplexing unit 15 demultiplexes the intensity modulation light P_{IM} into the wavelength component of the carrier light P_{CAR} and the wavelength component of the pilot light P_{PIL}. Since demultiplexing of intensity modulation light P_{IM} by the light wavelength demultiplexing unit 15 itself is a known technique, detailed description thereof will be omitted.

The light wavelength demultiplexing unit 15 outputs the wavelength component of the carrier light P_{CAR} illustrated in FIG. 7A to the light pulse compression unit 16, and outputs the wavelength component of the pilot light P_{PIL} illustrated in FIG. 7B to the control unit 18.

FIG. 7A is an explanatory view illustrating the time waveform of the wavelength component of the carrier light P_{CAR}.

In FIG. 7A, the horizontal axis indicates a time, and the vertical axis indicates the light intensity of the wavelength component of the carrier light P_{CAR}.

FIG. 7B is an explanatory view illustrating the time waveform of the wavelength component of the pilot light P_{PIL}.

In FIG. 7B, the horizontal axis indicates a time, and the vertical axis indicates the light intensity of the wavelength component of the pilot light P_{PIL}.

The light pulse compression unit 16 receives the wavelength component of the carrier light P_{CAR} from the light wavelength demultiplexing unit 15.

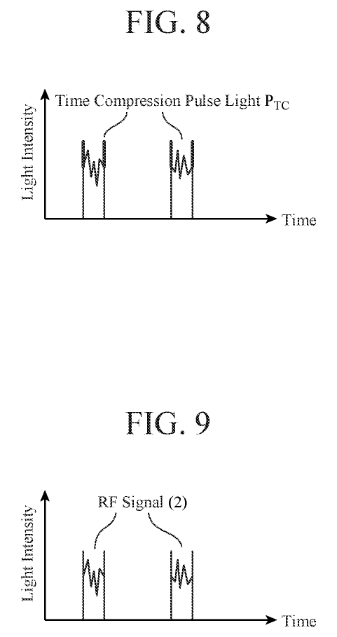

The light pulse compression unit 16 compresses the wavelength component of the carrier light P_{CAR} along the time axis as illustrated in FIG. 8.

The light pulse compression unit 16 outputs the time compression pulse light P_{TC} that is the compressed wavelength component of the carrier light P_{CAR} to the photoelectric conversion unit 17.

FIG. 8 is an explanatory view illustrating a time waveform of the time compression pulse light P_{TC}.

In FIG. 8, the horizontal axis indicates a time, and the vertical axis indicates the light intensity of the time compression pulse light P_{TC}.

The photoelectric conversion unit 17 receives the time compression pulse light P_{TC} from the light pulse compression unit 16.

The photoelectric conversion unit 17 converts the time compression pulse light P_{TC} into an electrical signal, and outputs the RF signal (2) that is the electrical signal to the communication circuit 2. The RF signal (2) relates to the time compression pulse light P_{TC} that is the wavelength component of the carrier light P_{CAR} compressed along the time axis. Hence, the frequency f₂ of the RF signal (2) is higher than the frequency f₁ of the RF signal (1).

FIG. 9 is an explanatory view illustrating a time waveform of the RF signal (2).

In FIG. 9, the horizontal axis indicates a time, and the vertical axis indicates the light intensity of the RF signal (2).

When a temperature drift, a drift over time, or the like occurs in the light intensity modulation unit 14, a signal level of the RF signal (2) output from the photoelectric conversion unit 17 to the communication circuit 2 may deviate from the original signal level.

The frequency transition device 1 illustrated in FIG. 2 includes the control unit 18, and consequently can compensate for the deviation of the signal level.

The photoelectric conversion unit 18a of the control unit 18 receives the wavelength component of the pilot light P_{PIL} from the light wavelength demultiplexing unit 15.

The photoelectric conversion unit 18a converts the wavelength component of the pilot light P_{PIL} into the electrical signal E, and outputs the electrical signal E to the bias control circuit 18b.

The bias control circuit 18b receives the electrical signal E from the photoelectric conversion unit 18a.

The bias control circuit 18b controls the light intensity modulation of the light intensity modulation unit 14 by controlling the bias signal B to be applied to the light intensity modulation unit 14 on the basis of the electrical signal E.

More specifically, the bias control circuit 18b compares the electrical signal E and a threshold Th.

The threshold Th indicates a value of the electrical signal E output from the photoelectric conversion unit 18a when a temperature drift, a drift over time, or the like does not occur in the light intensity modulation unit 14. The value of the electrical signal E at a time when a temperature drift or the like does not occur in the light intensity modulation unit 14 is determined in accordance with, for example, characteristics of the light intensity modulation unit 14.

The threshold Th may be stored in an internal memory of the bias control circuit 18b, or may be given from the outside of the frequency transition device 1.

The bias control circuit 18b controls the bias signal B to be applied to the light intensity modulation unit 14 in such a way that, if the electrical signal E is greater than the threshold Th, the light intensity of the intensity modulation light P_{IM} output from the light intensity modulation unit 14 becomes less.

The bias control circuit 18b controls the bias signal B to be applied to the light intensity modulation unit 14 in such a way that, if the electrical signal E is smaller than the threshold Th, the light intensity of the intensity modulation light P_{IM} output from the light intensity modulation unit 14 is greater.

The bias control circuit 18b maintains the bias signal B to be applied to the light intensity modulation unit 14 if the electrical signal E and the threshold Th are equal.

Here, if the electrical signal E is greater than the threshold Th, the bias control circuit 18b controls the bias signal B to be applied to the light intensity modulation unit 14 in such a way that the light intensity of the intensity modulation light P_{IM} output from the light intensity modulation unit 14 becomes less. However, this is merely an example, and, if the electrical signal E is greater than the threshold Th, as long as a difference between the electrical signal E and the threshold Th is a setting value or more, the bias control circuit 18b may control the bias signal B to be applied to the light intensity modulation unit 14 in such a way that the light intensity of the intensity modulation light P_{IM} output from the light intensity modulation unit 14 becomes less.

Furthermore, here, if the electrical signal E is less than the threshold Th, the bias control circuit 18b controls the bias signal B to be applied to the light intensity modulation unit 14 in such a way that the light intensity of the intensity modulation light P_{IM} output from the light intensity modulation unit 14 becomes greater. However, this is merely an example, and, even if the electrical signal E is less than the threshold Th, as long as the difference between the electrical signal E and the threshold Th is the setting value or more, the bias control circuit 18b may control the bias signal B to be applied to the light intensity modulation unit 14 in such a way that the light intensity of the intensity modulation light P_{IM} output from the light intensity modulation unit 14 becomes greater.

According to above Embodiment 1, the frequency transition device 1 includes the light wavelength multiplexing unit 13 that performs wavelength multiplexing on pilot light having a wavelength different from that of the carrier light with respect to carrier light, and the light intensity modulation unit 14 that performs light intensity modulation on post-pilot light multiplexing carrier light obtained by the light wavelength multiplexing unit 13 with a frequency transition target signal, and outputs intensity modulation light that is post-light intensity modulation carrier light. Furthermore, the frequency transition device 1 includes the light wavelength demultiplexing unit 15 that multiplexes the intensity modulation light output from the light intensity modulation unit 14 into a wavelength component of the carrier light and a wavelength component of the pilot light, the light pulse compression unit 16 that compresses the wavelength component of the carrier light along the time axis, and outputs time compression pulse light that is the compressed wavelength component of the carrier light, and the control unit 18 that controls the light intensity modulation of the light intensity modulation unit 14 on the basis of the wavelength component of the pilot light. Consequently, even if a signal level of a post-frequency transition signal that is an electrical signal converted from time compression pulse light deviates from the original signal level, the frequency transition device 1 can recover the signal level of the post-frequency transition signal to the original signal level.

### Embodiment 2.

Embodiment 2 will describe a frequency transition device 1 that includes a spectrum shaping unit 19 that shapes the time waveform of the carrier light P_{CAR} generated by the carrier light generation unit 11.

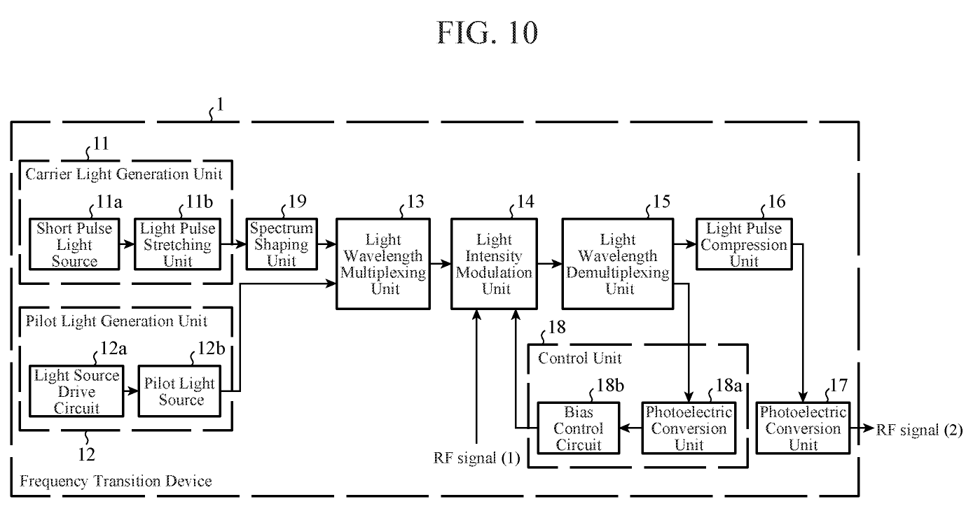

FIG. 10 is a configuration diagram illustrating the frequency transition device 1 according to Embodiment 2. Note that, in FIG. 10, the same reference numerals as those in FIG. 2 indicate identical or corresponding parts, and therefore detailed description thereof will be omitted.

The frequency transition device 1 illustrated in FIG. 10 includes the carrier light generation unit 11, the pilot light generation unit 12, the light wavelength multiplexing unit 13, the light intensity modulation unit 14, the light wavelength demultiplexing unit 15, the light pulse compression unit 16, the photoelectric conversion unit 17, the control unit 18, and the spectrum shaping unit 19.

In the frequency transition device 1 illustrated in FIG. 10, the carrier light generation unit 11 and the spectrum shaping unit 19 are connected by, for example, an optical fiber, and the spectrum shaping unit 19 and the light wavelength multiplexing unit 13 are connected by, for example, an optical fiber.

The spectrum shaping unit 19 is implemented by, for example, a wavelength selection switch.

The spectrum shaping unit 19 receives the carrier light P_{CAR} from the carrier light generation unit 11.

The spectrum shaping unit 19 shapes the time waveform of the carrier light P_{CAR}.

The spectrum shaping unit 19 outputs post-wavelength shaping carrier light P_{CAR}’ to the light wavelength multiplexing unit 13.

In the frequency transition device 1 illustrated in FIG. 10, the spectrum shaping unit 19 is disposed between the light pulse stretching unit 11b and the light wavelength multiplexing unit 13. However, this is merely an example, and, for example, the light wavelength multiplexing unit 13 may have the function of the spectrum shaping unit 19.

Next, the operation of the frequency transition device 1 illustrated in FIG. 10 will be described. In this regard, the components other than the spectrum shaping unit 19 are similar to those of the frequency transition device 1 illustrated in FIG. 2, and therefore an operation of the spectrum shaping unit 19 will be mainly described.

The light intensity of the carrier light P_{CAR} generated by the carrier light generation unit 11 is the greatest at the wavelength λ_{C} and becomes less as the wavelength λ_{C} becomes shorter as illustrated in FIG. 4C. Furthermore, the light intensity of the carrier light P_{CAR} becomes less as the wavelength λ_{C} becomes longer.

That is, the light intensity of the carrier light P_{CAR} has wavelength dependency, and distortion may occur in the carrier light P_{CAR}.

The spectrum shaping unit 19 receives the carrier light P_{CAR} from the carrier light generation unit 11.

The spectrum shaping unit 19 shapes the time waveform of the carrier light P_{CAR} to resolve the distortion of the carrier light P_{CAR}.

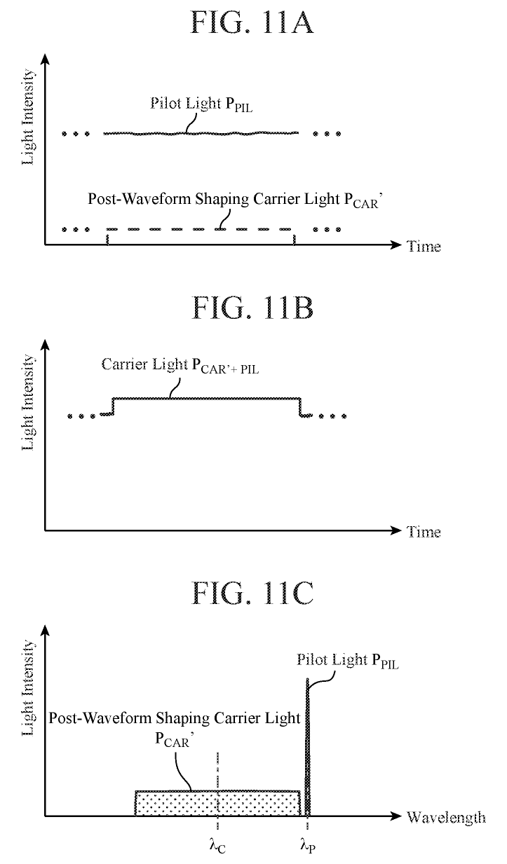

The distortion occurs in the carrier light P_{CAR} illustrated in FIG. 4A. The distortion is resolved in the post-waveform shaping carrier light P_{CAR}’ illustrated in FIG. 11A.

More specifically, the spectrum shaping unit 19 shapes the time waveform of the carrier light P_{CAR} as illustrated in FIG. 11A by adjusting a light attenuation amount of each frequency slice of the carrier light P_{CAR}.

The spectrum shaping unit 19 outputs the post-wavelength shaping carrier light P_{CAR}’ to the light wavelength multiplexing unit 13.

FIG. 11A is an explanatory view illustrating a time waveform of each of the post-waveform shaping carrier light P_{CAR}’ and the pilot light P_{PIL}. In FIG. 11A, the horizontal axis indicates a time, and the vertical axis indicates a light intensity of each of the post-waveform shaping carrier light P_{CAR’} and the pilot light P_{PIL}.

FIG. 11B is an explanatory view illustrating post-waveform shaping carrier light P_{CAR’+PIL} on which the pilot light P_{PIL} has been subjected to wavelength multiplexing. In FIG. 11B, the horizontal axis indicates a time, and the vertical axis indicates the light intensity of the carrier light P_{CAR’+PIL}.

FIG. 11C is an explanatory view illustrating the wavelength of each of the carrier light P_{CAR}’ and the pilot light P_{PIL}. In FIG. 11C, the horizontal axis indicates a wavelength, and the vertical axis indicates a light intensity of each of the carrier light P_{CAR’} and the pilot light P_{PIL}.

FIG. 11C illustrates an example where the wavelength λ_{P} of the pilot light P_{PIL} is longer than the wavelength range of the carrier light P_{CAR’}. However, this is merely an example, and the wavelength λ_{P} of the pilot light P_{PIL} may be shorter than the wavelength range of the carrier light P_{CAR’}.

The spectrum shaping unit 19 shapes the time waveform of the carrier light P_{CAR}, so that, compared to the frequency transition device 1 illustrated in FIG. 2, it is possible to generate the carrier light P_{CAR’} that does not interfere with the wavelength of the pilot light P_{PIL} even when the wavelength λ_{C} and the wavelength λ_{P} are made closer. A difference between the wavelength λ_{C} and the wavelength λ_{P} illustrated in FIG. 11 is less than a difference between the wavelength λ_{C} and the wavelength λ_{P} illustrated in FIG. 4C.

The light wavelength multiplexing unit 13 receives the post-waveform shaping carrier light P_{CAR’} illustrated in FIG. 11A from the carrier light generation unit 11, and receives the pilot light P_{PIL} illustrated in FIG. 11A from the pilot light generation unit 12.

The light wavelength multiplexing unit 13 performs wavelength multiplexing on the pilot light P_{PIL} with respect to the post-wavelength shaping carrier light P_{CAR’}.

As illustrated in FIG. 11B, the light wavelength multiplexing unit 13 outputs to the light intensity modulation unit 14 the post-wavelength shaping carrier light P_{CAR’+PIL} on which the pilot light P_{PIL} has been subjected to wavelength multiplexing.

The light intensity modulation unit 14 receives the RF signal (1) from the outside, receives the carrier light P_{CAR’+PIL} from the light wavelength multiplexing unit 13, and receives the bias signal B from the control unit 18.

The light intensity modulation unit 14 performs light intensity modulation on the carrier light P_{CAR’+PIL} with the RF signal (1).

The light intensity modulation unit 14 outputs the intensity modulation light P_{IM} that is the post-light intensity modulation carrier light to the light wavelength demultiplexing unit 15.

According to above Embodiment2, the frequency transition device 1 illustrated in FIG. 10 includes the spectrum shaping unit 19 that shapes the time waveform of the carrier light generated by the carrier light generation unit 11, and outputs the post-waveform shaping carrier light to the light wavelength multiplexing unit 13. Consequently, the frequency transition device 1 illustrated in FIG. 10 can enhance compensation accuracy for a deviation of a signal level compared to the frequency transition device 1 illustrated in FIG. 2.

Note that, in the present disclosure, free combinations of the embodiments, modification of arbitrary components in the embodiments, or omission of arbitrary components in the embodiments are possible.

### INDUSTRIAL APPLICABILITY

The present disclosure is suitable to a frequency transition device and a communication device.

### REFERENCE SIGNS LIST

1: Frequency transition device,

2: Communication circuit,

3: Antenna,

11: Carrier light generation unit (Carrier light generator),

11a: Short pulse light source,

11b: Light pulse stretching unit,

12: Pilot light generation unit (Pilot light generator),

12a: Light source drive circuit, 12b: Pilot light source,

13: Light wavelength multiplexing unit (Light wavelength multiplexer),

14: Light intensity modulation unit (Light intensity modulator),

15: Light wavelength demultiplexing unit (Light wavelength demultiplexer),

16: Light pulse compression unit (Light pulse compressor),

17: Photoelectric conversion unit (Photoelectric converter),

18: Control unit (Controller),

18a: Photoelectric conversion unit (Photoelectric converter),

18b: Bias control circuit,

19: Spectrum shaping unit (Spectrum shaper)

What is claimed is:

1. A frequency transition device comprising:
a light wavelength multiplexer to perform wavelength multiplexing on pilot light with respect to carrier light, the pilot signal having a wavelength different from a wavelength of the carrier light;
a light intensity modulator to perform light intensity modulation on post-pilot light multiplexing carrier light obtained by the light wavelength multiplexer with a frequency transition target signal, and output intensity modulation light that is post-light intensity modulation carrier light;
a light wavelength demultiplexer to demultiplex the intensity modulation light output from the light intensity modulator into a wavelength component of the carrier light and a wavelength component of the pilot light;
a light pulse compressor to compress the wavelength component of the carrier light along a time axis, and output time compression pulse light that is the compressed wavelength component of the carrier light; and
a controller to control a light intensity of the intensity modulation light output from the light intensity modulator on a basis of the wavelength component of the pilot light.

2. The frequency transition device according to claim 1, wherein
the controller controls the light intensity of the intensity modulation light output from the light intensity modulator by converting the wavelength component of the pilot light into an electrical signal, and controlling a bias signal to be applied to the light intensity modulator on a basis of the electrical signal.

3. The frequency transition device according to claim 1, further comprising:
a carrier light generator to generate carrier light by stretching pulse light along the time axis, and output the generated carrier light to the light wavelength multiplexer; and
a pilot light generator to generate the pilot light having the different wavelength from the wavelength of the carrier light generated by the carrier light generator, and output the generated pilot light to the light wavelength multiplexer.

4. The frequency transition device according to claim 3, further comprising a spectrum shaper to shape a time waveform of the carrier light generated by the carrier light generator, and output post-waveform shaping carrier light to the light wavelength multiplexer.

5. The frequency transition device according to claim 1, further comprising a photoelectric converter to convert the time compression pulse light output from the light pulse compressor into an electrical signal, and output the electrical signal as a post-frequency transition signal.

6. A communication device comprising:
the frequency transition device according to claim 5; and
a communication circuit to output to an antenna the electrical signal output from the photoelectric converter of the frequency transition device.
